(19) United States
(12) Patent Application Publication
(10) Pub. No.: US 2010/0206543 A1
(43) Pub. Date: Aug. 19, 2010

(54) TWO-STAGE HEAT EXCHANGER WITH INTERSTAGE BYPASS

(76) Inventors: Brian M. Tylisz, LaPorte, IN (US); Andrew McDavid, Rolling Prairie, IN (US); Robert A. Countiss, Mebane, NC (US)

Correspondence Address: CARLSON, GASKEY & OLDS, P.C., 400 WEST MAPLE ROAD, SUITE 350, BIRMINGHAM, MI, 48009, US

(21) Appl. No.: 12/370,632

(22) Filed: Feb. 13, 2009

(51) Int. Cl. G05D 23/00

(52) U.S. Cl. 165/297

(57) ABSTRACT

A fluid cooler comprises a first stage fluid cooler and a downstream second stage fluid cooler. A flow line connects the first and second stages. A valve senses a condition of the fluid in the flow line, and to bypass the second stage fluid cooler if it is determined that additional cooling is not necessary. An air compressor incorporating the cooler is also claimed as is a method of operating a fluid cooler.

### BACKGROUND OF THE INVENTION

This application relates to a two-stage oil cooler, wherein an interstage bypass directs oil around the second stage, when additional cooling is unnecessary.

Compressors typically require oil, which can become hot during operation of the compressor. Thus, oil is routed from the compressor through an oil cooler, such that the oil is periodically cooled and returned to the compressor. One application for a compressor is in an air compressor. Typically, the oil coolers are sized to handle high ambient temperature conditions, at which the oil will become quite hot. When the same oil cooler is used in lower ambient temperatures, the oil is not as hot, and there may be too much cooling capacity in the oil coolers.

Typical compressors may be provided with a valve that restricts the compressor intake to reduce its capacity, which can also result in the oil being cooler than the preferred operating temperature.

Compressors can also be associated with the ability to vary the speed of the compressor, thus reducing its capacity, which can also result in the oil being cooler.

The thermal cycles associated with an oversize oil cooler can induce stress in the core of the oil cooler, reducing its strength and its ability to withstand internal pressures.

It has been proposed to include a bypass valve into multi-stage heat exchangers. However, the valve associated with this arrangement was at a downstream end of a bypass line, and only served to reduce the amount of fluid passing through the second stage heat exchanger.

### SUMMARY OF THE INVENTION

A fluid cooler comprises a first stage fluid cooler and a downstream second stage fluid cooler. A flow line connects the first and second stages. A valve senses a condition of the fluid in the flow line, and bypasses the second stage fluid cooler if it is determined that additional cooling is not necessary. An air compressor incorporating the cooler is also claimed as is a method of operating a fluid cooler.

These and other features of the present invention can be best understood from the following specification and drawings, the following of which is a brief description.

### BRIEF DESCRIPTION OF THE DRAWINGS

FIG. 1 schematically shows a system incorporating the present invention.

FIG. 2 shows the FIG. 1 system in an alternative position.

### DETAILED DESCRIPTION OF THE PREFERRED EMBODIMENT

System 20 includes a compressor 22 that receives air from line 21, and compresses that air, delivering it towards a compressed air outlet 23. An oil separator vessel 25 is positioned on the outlet of the compressor 22, and includes a separator element 17. The separator may be as known. Separated oil flows through line 125 towards an oil cooler 27. Downstream of the oil cooler 27, oil is returned through a line 19 back to compressor 22. While the present invention is illustrated in an air compressor, an oil cooler 27 of this invention may be incorporated into use with other compressors for other applications, and for other cooling applications beyond compressor oil coolers.

The oil cooler 27 has at least two stages, and incorporates a first stage 24 and a downstream second stage 32. Oil from the compressor 22 passes into an inlet manifold 31 in first stage 24, then passes through flow channels, shown here schematically as tubes 26, to a discharge plenum 33. Air circulates around the channels and cools the oil. From the discharge manifold 33, the oil flows into a connecting flow line 28 leading to a connection 30 to an inlet manifold 34 of the second stage 32 of the oil cooler. While not illustrated, the second stage 32 will also include oil channels. It should be understood that the oil cooler stages 24 and 32, and the flow channels, may be of any one of numerous configurations, and may include fins, etc.

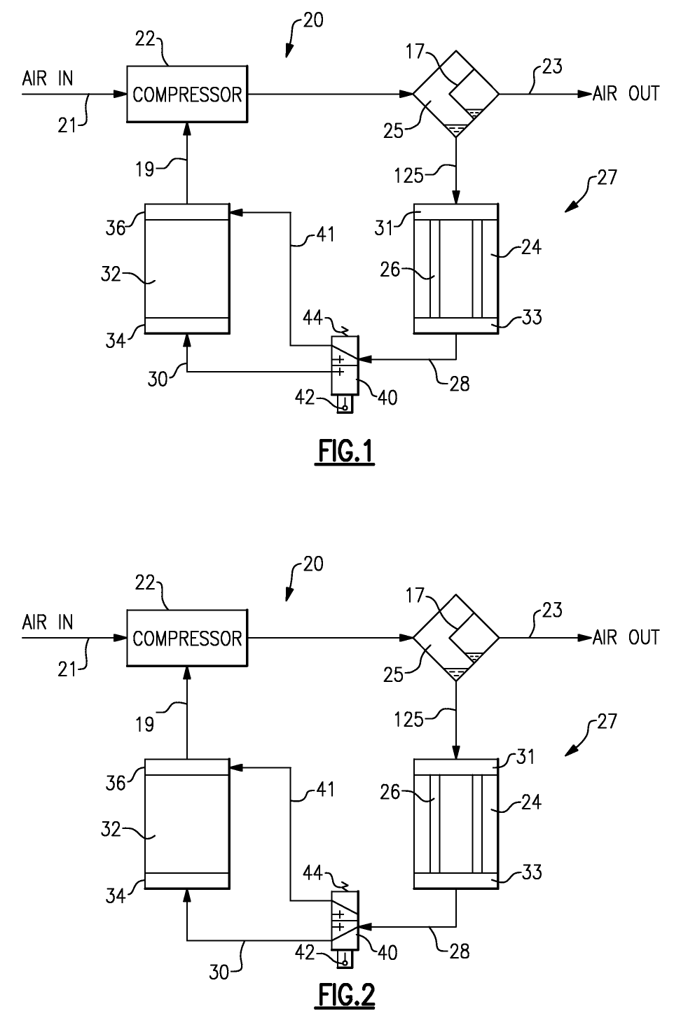

When inlet manifold 34 receives the oil from the line 30, it passes through the cooler and to a discharge manifold 36, which then leads to a line returning the oil to the compressor 22. A bypass line 41 is connected to line 28 and includes a valve 40. A spring 44 biases the valve to the position shown in FIG. 1. In the position shown in FIG. 1, the oil is bypassed around the second stage 32, and goes directly to the discharge manifold 36.

When the oil does not require additional cooling in second stage 32, the valve 40 remains in the position shown in FIG. 1, and the oil will bypass the second stage 32. All cooling will be done in the first stage 24, and the concerns mentioned above are avoided. A sensor 42 on the valve 40 monitors the temperature of the oil at line 28. If the oil temperature is above a threshold when reaching valve 40, then sensor 42 will drive the valve to the position shown in FIG. 2, at which position oil flows through the valve 40, and to line 30 leading to the second stage oil cooler 32.

As can be appreciated from the figures, the valves are either “full on” or “full off” and when in the FIG. 1 position, will entirely bypass the second stage oil cooler 32. In the position of FIG. 2, no fluid will flow through the bypass line, and it will be entirely blocked off. In addition, since the valve is at an upstream end of the bypass line, there will not be a dead volume of the fluid. The specifically disclosed valve will transition between the full on and full off positions, and there will be a state of transition where the fluid may be partially directed to both destinations. However, this will be a temporary condition, and the valve will eventually arrive at the FIG. 1 or the FIG. 2 position.

In one embodiment, the sensor 42 may be a wax element that expands when exposed to a predetermined temperature to drive the valve to the FIG. 2 position. On the other hand, other temperature sensitive elements may be utilized. In addition, the valve 40 could be provided by an electronically controlled valve wherein an electronic sensor senses temperatures and drives the valve to the FIG. 2 position when the predetermined temperature is met.

While the valve 40 and its associated components including sensor 42 and spring 44 are shown schematically, a worker of ordinary skill in the art would recognize how to provide a valve that can operate to achieve the disclosed functions. Moreover, other types of valves that operate in other manners would come within the scope of this invention. As an example, a valve may be normally biased to the FIG. 2 position, and driven to the FIG. 1 position, and would still come within the scope of this invention.

In addition, while the figures show an oil cooler, this invention can be incorporated into coolers for other fluids besides oil.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A fluid cooler comprising:
a first stage fluid cooler and a downstream second stage fluid cooler, and a flow line connecting said first and second stage fluid coolers; and
a valve for sensing a condition of the fluid in said flow line, and to bypass said second stage fluid cooler if it is determined that additional cooling is not necessary.

2. The fluid cooler as set forth in claim 1, wherein said valve senses the temperature of the fluid.

3. The fluid cooler as set forth in claim 2, wherein a bypass line is connected into said flow line, said bypass line communicating with said valve.

4. The fluid cooler as set forth in claim 1, wherein said valve includes a temperature sensitive sensor, which expands to move the valve to block the bypass when a predetermined temperature is met.

5. The fluid cooler as set forth in claim 1, wherein an oil is passed from a compressor through said fluid cooler.

6. The fluid cooler as set forth in claim 1, wherein there is a discharge manifold at a downstream end of said second stage fluid cooler, and the fluid is bypassed directly into the discharge manifold.

7. The fluid cooler as set forth in claim 6, wherein said second stage fluid cooler also has an inlet manifold, and flow channels are provided between said inlet manifold and said discharge manifold, and allow an included fluid to be cooled by air as it passes through said flow channels.

8. The fluid cooler as set forth in claim 1, wherein said valve is at an upstream end of a bypass line.

9. A compressor comprising:
a compressor having an oil inlet; and
an oil supply line leading to a fluid cooler from said compressor, and a fluid return line leading from said fluid cooler and back to said compressor, said fluid cooler comprising a first stage fluid cooler and a downstream second stage fluid cooler, and a flow line connecting said first and second stage fluid coolers, a valve for sensing a condition of the fluid in said flow line, and to bypass said second stage fluid cooler if it is determined that additional cooling is not necessary.

10. The compressor as set forth in claim 9, wherein said valve senses the temperature of the fluid.

11. The compressor as set forth in claim 10, wherein a bypass line is connected into said flow line, said bypass line communicating with said valve.

12. The compressor as set forth in claim 9, wherein there is a discharge manifold at a downstream end of said second stage fluid cooler, and the fluid is bypassed directly into the discharge manifold.

13. The compressor as set forth in claim 12, wherein said second stage fluid cooler also has an inlet manifold, and flow channels are provided between said inlet manifold and said discharge manifold, and allow an included fluid to be cooled by air as it passes through said flow channels.

14. The compressor as set forth in claim 9, wherein said valve includes a temperature sensitive sensor, which expands to move the valve to block the bypass when a predetermined temperature is met.

15. The compressor as set forth in claim 9, wherein said valve is at an upstream end of a bypass line.
